(19) United States
(12) Patent Application Publication
(10) Pub. No.: US 2023/0411068 A1
(43) Pub. Date: Dec. 21, 2023

(54) INDUCTOR AND METHOD FOR MANUFACTURING INDUCTOR

(71) Applicant: Panasonic Intellectual Property Management Co., Ltd., Osaka (JP)

(72) Inventors: Kiyoshi TAKAGI, Hyogo (JP); Masahiro ENOMOTO, Hyogo (JP); Hiroshi TOMITA, Hyogo (JP)

(21) Appl. No.: 18/247,707

(22) PCT Filed: Oct. 12, 2021
(86) PCT No.: PCT/JP2021/037682

§ 371 Date: Apr. 3, 2023

(30) Foreign Application Priority Data
Oct. 21, 2020 (JP) 2020-176575

(51) Int. Cl. H01F 27/29; H01F 27/28; H01F 27/255; H01F 41/10; H01F 41/02

(52) U.S. Cl. CPC H01F 27/292; H01F 27/2828; H01F 27/255; H01F 41/10; H01F 41/0246

(57) ABSTRACT

An inductor includes: an exterior member having a bottom surface and a side surface; and an electric conductive member partially covered by the exterior member. The electric conductive member includes a coil portion covered by the exterior member; lead portions connected to both ends of the coil portion, extending toward the bottom surface, and covered by the exterior member; and terminal electrodes connected to the lead portions and exposed from the bottom surface. The side surface includes recesses recessed inward of the exterior member from the side surface and connected to the bottom surface. The terminal electrodes extend along the bottom surface toward the recesses, are bent from the bottom surface toward the recesses, and housed therein. At least a part of each lead portion is opposite to the recess. Each lead portion has a thickness smaller than a diameter or a thickness of a wire of the coil portion.

### CROSS-REFERENCE OF RELATED APPLICATIONS

This application is the U.S. National Phase under 35 U.S.C. § 371 of International Patent Application No. PCT/JP2021/037682, filed on Oct. 12, 2021, which in turn claims the benefit of Japanese Patent Application No. 2020-176575, filed on Oct. 21, 2020, the entire disclosures of which applications are incorporated by reference herein.

### TECHNICAL FIELD

The present disclosure relates to an inductor and a method for manufacturing the inductor.

### BACKGROUND ART

An inductor is used, for example, in a DC-DC converter device to raise and lower the power supply voltage and smoothing the direct current (DC). In recent years, the current used in electronic devices has increased, and there has been a demand for increasing the magnetic saturation current of inductors used in DC-DC converter devices. Patent Literature (PTL) 1 discloses an inductor including a coil portion, a plurality of exterior members surrounding the coil portion, and terminal electrodes connected to the coil portion and led out to the bottom surface of the exterior member.

### CITATION LIST

### Patent Literature

[PTL 1] Japanese Unexamined Patent Application Publication No. 2019-129253

### SUMMARY OF INVENTION

### Technical Problem

In conventional inductors, the magnetic saturation current may decrease depending on the shape of the exterior member. An object of the present disclosure is to provide an inductor that can inhibit decrease in the magnetic saturation current.

### Solution to Problem

An inductor according to one aspect of the present disclosure includes: an exterior member including a magnetic material and having a bottom surface and a side surface connected to the bottom surface; and an electric conductive member including a metallic material and partially covered by the exterior member. The electric conductive member includes (i) a coil portion covered by the exterior member, (ii) lead portions each connected to a corresponding one of both ends of the coil portion, extending toward the bottom surface, and covered by the exterior member, and (iii) terminal electrodes each connected to a corresponding one of the lead portions and exposed from the bottom surface of the exterior member, the side surface of the exterior member includes recesses that are recessed inward of the exterior member from the side surface and connected to the bottom surface, the terminal electrodes each extend along the bottom surface toward a corresponding one of the recesses, are bent from the bottom surface toward the corresponding one of the recesses, and housed in the corresponding one of the recesses, at least a part of each of the lead portions is located opposite to the corresponding one of the recesses, and each of the lead portions has a thickness smaller than a diameter or a thickness of a wire of the coil portion.

Moreover, a method for manufacturing an inductor according to the present disclosure is a method for manufacturing an inductor including (i) an exterior member including a magnetic material and having a bottom surface and a side surface connected to the bottom surface and (ii) an electric conductive member partially covered by the exterior member. The method includes: forming the electric conductive member by pressing both ends of a metal wire using a press mold, the electric conductive member including, on both sides sandwiching a body of the metal wire, a lead portion and a terminal electrode each having a flat shape and being thinner than the body; compression molding the magnetic material to cover the body and lead portions and not to cover terminal electrodes using a mold to form the exterior member and recesses in the side surface of the exterior member, the recesses being connected to the bottom surface, the lead portions each being the lead portion, the terminal electrodes each being the terminal electrode; and bending each of the terminal electrodes from the bottom surface of the exterior member toward and along a corresponding one of the recesses, and housing the terminal electrode in the corresponding one of the recesses.

### Advantageous Effects of Invention

The inductor, etc. according to the present disclosure can inhibit decrease in the magnetic saturation current.

### BRIEF DESCRIPTION OF DRAWINGS

FIG. 1 is a sectional view of an inductor in a comparison example.

FIG. 2 is front, side, and bottom views of an inductor according to an embodiment.

FIG. 3 is a sectional view of the inductor according to the embodiment.

FIG. 4 is a sectional view of another example of the inductor according to the embodiment.

FIG. 5 is a flowchart illustrating a method for manufacturing the inductor according to the embodiment.

FIG. 6 is a diagram illustrating a step of forming an electric conductive member in the method for manufacturing the inductor according to the embodiment.

FIG. 7 is a diagram illustrating a step of forming a coil portion in the method for manufacturing the inductor according to the embodiment.

FIG. 8 is a diagram illustrating a step of compression molding in the method for manufacturing the inductor according to the embodiment.

FIG. 9 is a diagram illustrating a step of bending in the method for manufacturing the inductor according to the embodiment.

FIG. 10 is a sectional view of an inductor according to other embodiments.

### DESCRIPTION OF EMBODIMENTS

### (Circumstances Leading to the Present Disclosure)

As described above, in recent years, the current used in electronic devices has increased, and there has been a demand for increasing the magnetic saturation current of inductors. On the other hand, a circuit board on which an inductor is mounted is required to reduce the surface area for mounting the inductor and to secure the connection strength of the inductor to the circuit board.

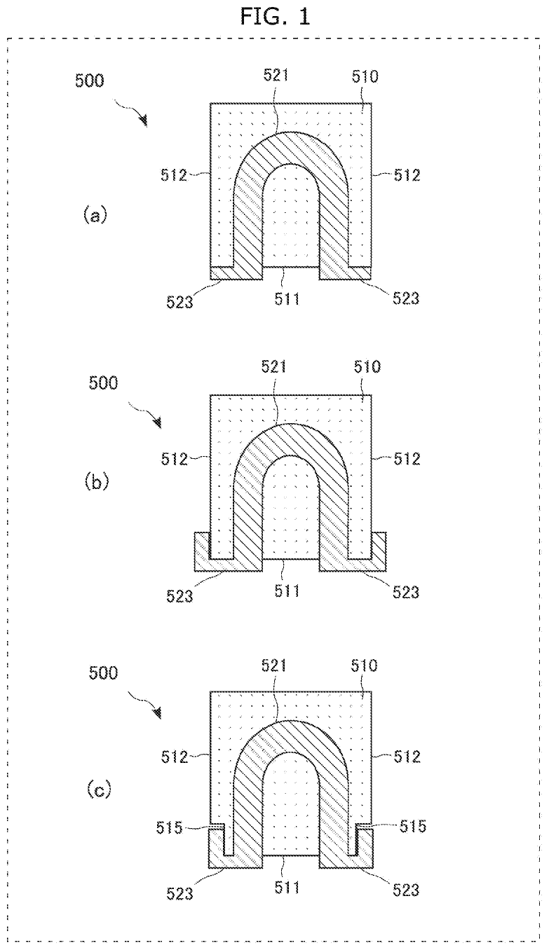

FIG. 1 is a sectional view of inductor 500 in a comparison example. Inductor 500 illustrated in (a) in FIG. 1 is similar to the inductor according to PTL 1. Inductor 500 includes coil portion 521, exterior member 510 surrounding coil portion 521, and terminal electrodes 523 connected to coil portion 521. Each terminal electrode 523 is formed along bottom surface 511 of exterior member 510 and extends toward side surface 512, which is outside of exterior member 510.

In this inductor 500, terminal electrodes 523 exposed from exterior member 510 are formed only on the bottom surface 511 side of exterior member 510. Therefore, when inductor 500 is mounted on a circuit board, solder fillets cannot be sufficiently formed, and the connection strength of inductor 500 to the circuit board cannot be secured.

In order to solve this problem, for example, as illustrated in (b) in FIG. 1, it is contemplated to extend the length of the metal plate constituting terminal electrodes 523, bend the metal plate from the bottom surface 511 side to be in contact with side surfaces 512, and form terminal electrodes 523 also on side surfaces 512. With this, terminal electrodes 523 formed on side surfaces 512 can be used to form solder fillets to ensure the connection strength of inductor 500 to the circuit board. However, when there are terminal electrodes 523 on side surfaces 512 of exterior member 510, the surface area for mounting inductor 500 increases as the thickness of each terminal electrode 523 increases.

In order to solve this problem, for example, as illustrated in (c) in FIG. 1, it is contemplated to provide recesses 515 in side surfaces 512 of exterior member 510 and house terminal electrodes 523 in recesses 515. However, when recesses 515 are provided in side surfaces 512 of exterior member 510, the wall thickness of exterior member 510 between each recess 515 and coil portion 521 is reduced and magnetic saturation is likely to occur. Therefore, there is a problem that the magnetic saturation current of inductor 500 decreases.

To address this, an inductor according to the present disclosure includes a configuration which will be described below to inhibit decrease in the magnetic saturation current.

The following specifically describes embodiments with reference to the drawings.

Note that each embodiment described below shows a specific example. Numerical values, shapes, materials, structural elements, the arrangement positions and connection of the structural elements, steps, the processing order of the steps, etc. shown in the following embodiment are mere examples, and are not intended to limit the scope of the present disclosure. Among the structural elements in the following embodiments, structural elements not recited in any one of the independent claims are described as optional structural elements.

Each figure shows an X-axis, a Y-axis, and a Z-axis which mean three directions orthogonal to each other, and these axes are used for explanation, as necessary. Each axis is provided for illustrative purposes only and does not limit the direction and orientation in which an inductor is used.

### Embodiment

### [Configuration]

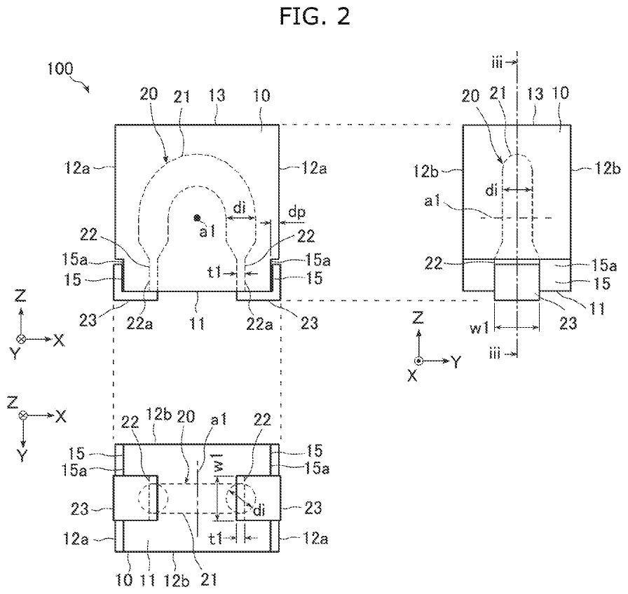

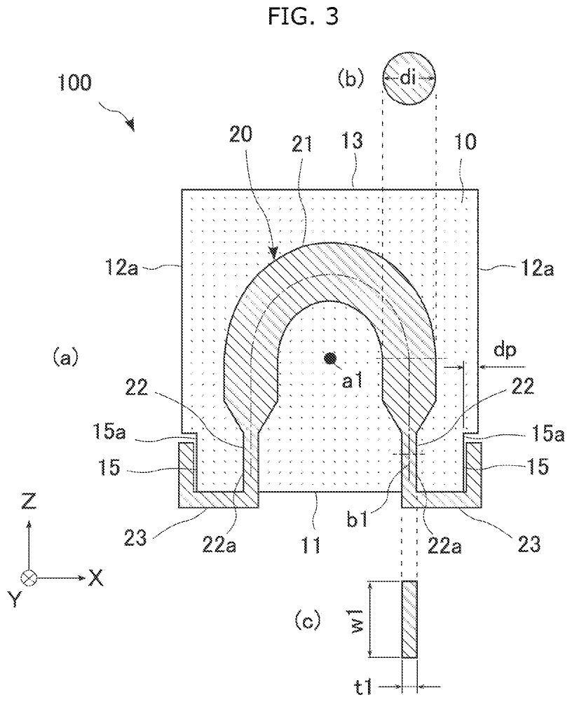

An inductor according to an embodiment will be described with reference to FIG. 2 and FIG. 3. An inductor is a passive element that stores electric energy flowing through an electric conductive member as magnetic energy.

FIG. 2 is front, side, and bottom views of inductor 100 according to the embodiment. FIG. 3 is a sectional view of inductor 100. In FIG. 3, (a) is a sectional view taken along line iii-iii in FIG. 2, (b) is a transverse cross-sectional view of the wire of coil portion 21, and (c) is a transverse cross-sectional view of lead portion 22.

As illustrated in FIG. 2 and FIG. 3, inductor 100 includes exterior member 10 and electric conductive member 20 partially covered by exterior member 10.

As an example, inductor 100 is a rectangular parallelepiped metal composite, and the approximate outline is determined by the shape of exterior member 10. Note that exterior member 10 may be formed into any shape by molding. In other words, inductor 100 having any shape can be produced based on the shape of exterior member 10 at the time of molding. Inductor 100 according to the present embodiment includes exterior member 10 having a dimension of at least 9 mm and at most 10 mm in the X-axis direction, which is along the X-axis, a dimension of at least 4.4 mm and at most 6 mm in the Y-axis direction, which is along the Y-axis, and a dimension of at least 6 mm and at most 10 mm in the Z-axis direction, which is along the Z-axis.

Exterior member 10 is the outer shell of inductor 100 and partially covers electric conductive member 20. Exterior member 10 is a dust core including, for example, metal magnetic powder and resin material. Note that exterior member 10 may be formed using any magnetic materials. For example, ferrite or other materials may be used. As the metal magnetic powder, particulate material having a predetermined elemental composition may be used, such as Fe—Si—Al based, Fe—Si based, Fe—Si—Cr based, or Fe—Si—Cr—B based particulate material. As the resin material, a material such as silicone that can maintain a certain shape by insulating the particles of the metal magnetic powder while bonding the particles together is selected.

Exterior member 10 is, for example, a rectangular parallelepiped shape with bottom surface 11, four side surfaces connected to bottom surface 11, and top surface 13 connected to the four side surfaces and opposed to bottom surface 11. The four side surfaces are made up of two side surfaces 12a that are opposed to each other in the X-axis direction and two side surfaces 12b that are opposed to each other in the Y-axis direction. Each of the four side surfaces 12a and 12b has a flat surface perpendicular to bottom surface 11. Note that in each of the two side surfaces 12a, recess 15 is provided. Recess 15 is recessed inward of exterior member 10 from side surface 12a and connected to bottom surface 11.

Recess 15 is a recess formed at an intersection of bottom surface 11 and side surface 12a of exterior member 10. Two recesses 15 each are formed in a corresponding one of side surfaces 12a. The two recesses 15 are in the outer sides of exterior member 10 in the X-axis direction. Each recess 15 includes recess plane 15a parallel to side surface 12a. Note that recess plane 15a is a part of the contour of exterior member 10.

Electric conductive member 20 includes coil portion 21, lead portions 22 each connected to a corresponding one of both ends of coil portion 21, and terminal electrodes 23 each connected to a corresponding one of lead portions 22. Electric conductive member 20 according to the present embodiment includes one coil portion 21, two lead portions 22, and two terminal electrodes 23. Electric conductive member 20 is produced with a material selected from (i) a metallic material such as aluminum, copper, silver, and gold, and (ii) an alloy of metal and other materials. Coil portion 21, lead portions 22, and terminal electrodes 23 are names given to each portion formed by processing one member including the same material. Each portion will be described below in the following order: terminal electrode 23, coil portion 21, and lead portion 22.

Each terminal electrode 23 is a portion exposed from bottom surface 11 of exterior member 10 and not covered by exterior member 10. Each terminal electrode 23 extends along bottom surface 11 of exterior member 10 toward recess 15 in side surface 12a, is bent from bottom surface 11 toward recess 15, and housed in recess 15. For example, when inductor 100 is mounted on a circuit board, terminal electrodes 23 are connected to lands on the circuit board via solder. Solder fillets are formed on terminal electrodes 23 housed in recesses 15.

Coil portion 21 is a portion covered by exterior member 10. The number of turns of coil portion 21 is, for example, at least 0.5 turns and less than 1.0 turn. The number of turns of coil portion 21 illustrated in FIG. 2 and FIG. 3 is 0.5 turns. Coil portion 21 is U-shaped and is formed, for example, by bending a metal wire. The transverse cross section of the metal wire included in coil portion 21 is circular, and the aspect ratio of the transverse cross section is 1:1.

Coil portion 21 is arranged such that winding axis a1 of coil portion 21 is in the Y-axis direction. Moreover, coil portion 21 is located closer to top surface 13 than lead portion 22, which will be described below, and is surrounded by top surface 13 and side surfaces 12a and 12b. Coil portion 21 includes a curved part wound 0.5 turns and straight parts connected to the curved part. Each of the straight parts of coil portion 21 is located opposite to side surface 12a of exterior member 10 and is connected to lead portion 22.

Each lead portion 22 is a portion also covered by exterior member 10. Lead portion 22 is a drawn conductor for connecting coil portion 21 to terminal electrode 23, and provided to extend from a corresponding one of both ends of coil portion 21 toward bottom surface 11 of exterior member 10. Note that lead portion 22 has a function of generating inductance components as with coil portion 21.

Lead portions 22 are located between two recesses 15 in the X-axis direction, and at least a part of each lead portion is located opposite to recess 15 of exterior member 10. Specifically, each lead portion 22 is provided along axis b1 of electric conductive member 20 and includes lead portion plane 22a opposite to recess plane 15a of recess 15. Moreover, lead portion 22 has a thickness in the direction perpendicular to side surface 12a, i.e., in the X-axis direction, and a width in the direction parallel to both of side surface 12a and bottom surface 11, i.e., in the Y-axis direction. Lead portion 22 is flat shaped or board shaped. For example, width w1 of lead portion 22 is at least 5 times and at most 10 times thickness t1 of lead portion 22.

In the present embodiment, thickness t1 of lead portion 22 is smaller than diameter di of the wire of coil portion 21 (t1<di). Moreover, width w1 of lead portion 22 is larger than diameter di of the wire of coil portion 21 (w1>d1). For example, diameter di of coil portion 21 is selected appropriately from the range of at least 1.3 mm and at most 1.8 mm, thickness t1 of lead portion 22 is 0.4 mm, and width w1 of lead portion 22 is 2.5 mm.

Moreover, the reduction in thickness of lead portion 22 with respect to coil portion 21 is greater than the reduction in wall thickness of exterior member 10 in recess 15. Specifically, if the difference between thickness t1 of lead portion 22 and diameter di of the wire of coil portion 21 is T (T=di−t1) and the depth of recess 15 recessed inward from side surface 12a of exterior member 10 is dp, the relation T/2≥dp is satisfied. For example, T/2 is at least 0.45 mm and at most 0.7 mm, and depth dp of recess 15 is 0.3 mm.

As described above, thickness t1 of lead portion 22 is smaller than diameter di of the wire of coil portion 21 in the present embodiment. With this configuration, it is possible to prevent the wall thickness of exterior member 10 between lead portion 22 and recess 15 from being thinner than necessary. As a result, occurrence of magnetic saturation can be inhibited in exterior member 10 between lead portion 22 and recess 15.

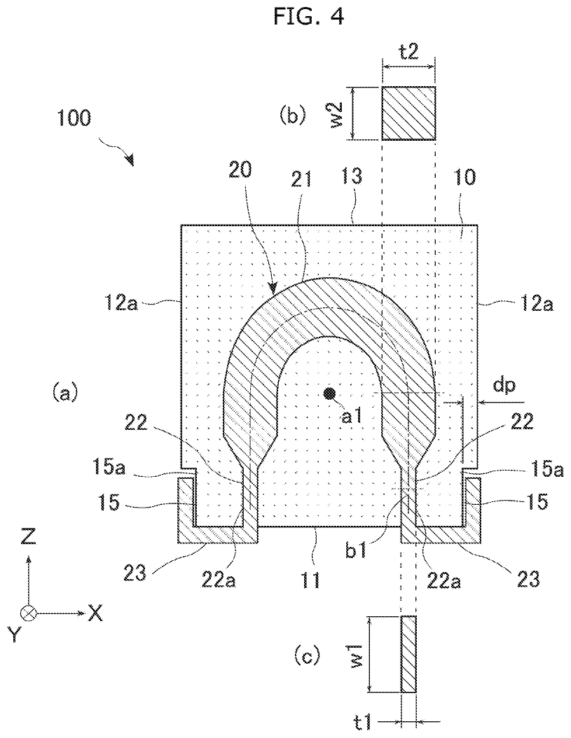

Note that an example in which the wire of coil portion 21 has a circular transverse cross section has been described above, but the present disclosure is not limited to this example. The transverse cross section may be square shaped (see FIG. 4).

FIG. 4 is a sectional view of another example of inductor 100 according to the embodiment. In FIG. 4, (a) is a sectional view of inductor 100 as viewed from the Y-axis direction, (b) is a transverse cross-sectional view of the wire of coil portion 21, and (c) is a transverse cross-sectional view of lead portion 22.

As illustrated in FIG. 4, even when the transverse cross section of the wire of coil portion 21 is square shaped, lead portions 22 and coil portion 21 have the same dimensional relation. Specifically, thickness t1 of each lead portion 22 may be thinner than thickness t2 of the wire of coil portion 21 (t1<t2), and width w1 of lead portion 22 may be wider than width w2 of the wire of coil portion 21 (w1>w2). Difference T between thickness t1 of lead portion 22 and thickness t2 of the wire of coil portion 21 is expressed as T=t2−t1, and the relation T/2≥dp may be satisfied with respect to depth dp of recess 15.

### [Manufacturing Method]

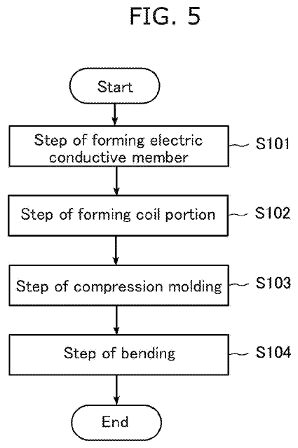

Next, a method for manufacturing inductor 100 described above will be described with reference to FIGS. 6 to 9 as appropriate, as well as FIG. 5.

FIG. 5 is a flowchart illustrating a method for manufacturing inductor 100 according to the embodiment. As illustrated in FIG. 5, the method for manufacturing inductor 100 includes step S101 of forming the electric conductive member, step S102 of forming the coil portion, step S103 of compression molding, and step S104 of bending.

FIG. 6 is a diagram illustrating step S101 of forming the electric conductive member in the method for manufacturing inductor 100 according to the embodiment. In FIG. 6, (a) illustrates metal wire 120 before pressing, and (b) and (c) illustrate electric conductive member 20 formed by pressing metal wire 120.

Step S101 of forming the electric conductive member is a step of forming, from metal wire 120, electric conductive member 20 integrally including coil portion 21, lead portions 22, and terminal electrodes 23.

Metal wire 120 is a single copper wire that extends in the direction of axis b1 and has a circular transverse cross section (see (a) in FIG. 6). In this step, both ends of metal wire 120 are pressed using a press mold (not illustrated). By pressing, flat portion 122 having plane 122a is formed on both sides sandwiching body 121 of metal wire 120 (see (b) in FIG. 6). Body 121 corresponds to coil portion 21, and flat portions 122 correspond to lead portions 22 and terminal electrodes 23. Flat portion 122 is formed along axis b1 of metal wire 120 by pressing metal wire 120 from above and below. Flat portion 122 is processed so that thickness t1 of flat portion 122 is smaller than diameter di of body 121. Note that axis b1 of metal wire 120 is the same as axis b1 of electric conductive member 20.

Three sides of the perimeter of flat portion 122 obtained by pressing are cut, and the dimensions of flat portion 122 in the width direction and the axis b1 direction (longitudinal direction) are adjusted (see (c) in FIG. 6). Width w1 of flat portion 122 after cutting is larger than diameter di of body 121. Through the pressing and cutting, electric conductive member 20 is formed.

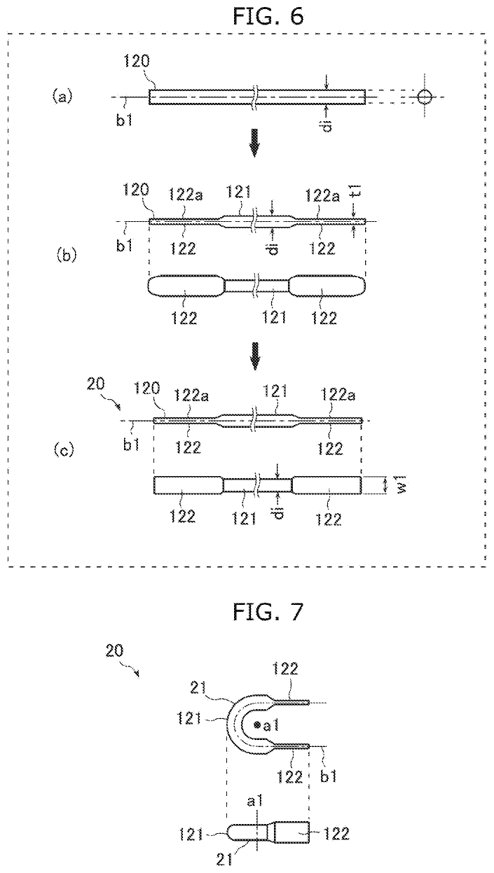

FIG. 7 is a diagram illustrating step S102 of forming the coil portion in the method for manufacturing inductor 100. In this step, coil portion 21 is formed by winding the middle of electric conductive member 20, i.e., body 121 of metal wire 120. In the present embodiment, coil portion 21 is formed by winding body 121 0.5 turns into a U-shape. After winding, flat portions 122 connected to both ends of coil portion 21 are located opposite to each other.

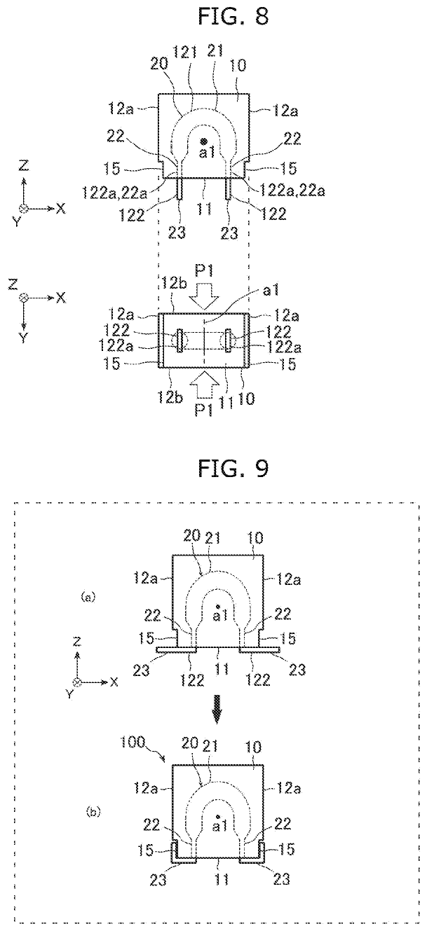

FIG. 8 is a diagram illustrating step S103 of compression molding in the method for manufacturing inductor 100. In this step, a magnetic material is compression molded using a mold (not illustrated). Specifically, exterior member 10 is formed by performing compression molding to cover the whole body 121 and parts of flat portions 122 with a magnetic material, and not to cover the other parts except for the parts of flat portions 122 with the magnetic material. As to flat portions 122, the parts of flat portions 122 covered by exterior member 10 become lead portions 22, and the other parts of flat portions 122 which are not covered by exterior member 10 become terminal electrodes 23. In this step, at the same time as the above compression molding, recesses 15 connected to bottom surface 11 are also formed in side surfaces 12a of exterior member 10. These recesses 15 are formed by providing protrusions that protrude inward on an inner wall of the mold.

Note that, in step S103 of compression molding, compression molding is performed with coil portion 21 placed in the mold and winding axis a1 of coil portion 21 being in compression direction P1 of the compression molding. Moreover, the compression molding is performed with lead portions 22 placed in the mold and planes 122a of flat portions 122, i.e., the planes of lead portions 22 (lead portion planes 22a), being in compression direction P1 of the compression molding. More specifically, the width direction of each lead portion 22 is in compression direction P1. The pressure to be applied in the compression molding is, for example, 5 ton/cm², and the thermosetting temperature is, for example, 185° C. Compression molding may be injection molding or transfer molding.

After compression molding, terminal electrodes 23, which are exposed and not covered by exterior member 10, protrude perpendicular to bottom surface 11 of exterior member 10. If necessary, for example, solder plating is applied to terminal electrodes 23.

FIG. 9 is a diagram illustrating step S104 of bending in the method for manufacturing inductor 100. In this step, as illustrated in (a) in FIG. 9, each terminal electrode 23 is bent at a right angle toward bottom surface 11 so that terminal electrode 23 extends along bottom surface 11 toward recess 15 of exterior member 10. Next, as illustrated in (b) in FIG. 9, the remaining part of each terminal electrode 23 except for the part along bottom surface 11 is bent at a right angle such that the remaining part is housed in recess 15, and housed in recess 15. In this way, each terminal electrode 23 is provided on the side surface 12a side of inductor 100. Inductor 100 is produced by the above-described steps: step S101 of forming the electric conductive member, step S102 of forming the coil portion, step S103 of compression molding, and step S104 of bending.

### Advantageous Effects, Etc.

As described above, inductor 100 according to the present disclosure includes: exterior member 10 including a magnetic material and having bottom surface 11 and side surface 12a connected to bottom surface 11; and electric conductive member 20 including a metallic material and partially covered by exterior member 10. Electric conductive member 20 includes (i) coil portion 21 covered by exterior member 10, (ii) lead portions 22 each connected to a corresponding one of both ends of coil portion 21, extending toward bottom surface 11, and covered by exterior member 10, and (iii) terminal electrodes 23 each connected to a corresponding one of lead portions 22 and exposed from bottom surface 11 of exterior member 10. Side surface 12a of exterior member 10 includes recesses 15 that are recessed inward of exterior member 10 from side surface 12a and connected to bottom surface 11. Terminal electrodes 23 each extend along bottom surface 11 toward a corresponding one of recesses 15, are bent from bottom surface 11 toward the corresponding one of recesses 15, and housed in the corresponding one of recesses 15. At least a part of each of lead portions 22 is located opposite to the corresponding one of recesses 15, and each of lead portions 22 has thickness t1 smaller than diameter di or thickness t2 of a wire of coil portion 21.

As described above, making thickness t1 of lead portion 22 smaller than diameter di or thickness t2 of the wire of coil portion 21 can inhibit that the wall thickness of exterior member 10 between lead portion 22 and recess 15 becomes thinner than necessary. As a result, it is possible to inhibit occurrence of magnetic saturation in exterior member 10 between lead portion 22 and recess 15, and to inhibit decrease in the magnetic saturation current of inductor 100. Moreover, expansion of the surface area for mounting inductor 100 can be inhibited by providing recesses 15 in side surface 12a of exterior member 10 and partially housing terminal electrodes 23 in recesses 15. Furthermore, providing terminal electrodes 23 not only on bottom surface 11 but also in recesses 15 in side surface 12a makes it possible to form solder fillets, for example, when inductor 100 is mounted on a circuit board. With this, the connection strength of inductor 100 to the circuit board can be ensured.

Moreover, each of lead portions 22 may have a flat shape.

With this configuration, since each lead portion 22 has a flat shape, the wall thickness of exterior member 10 between lead portion 22 and recess 15 can be secured. As a result, it is possible to inhibit occurrence of magnetic saturation in exterior member 10 between lead portion 22 and recess 15, and to inhibit decrease in magnetic saturation current of inductor 100.

Moreover, each of recesses 15 may include recess plane 15a parallel to side surface 12a, and each of lead portions 22 may include lead portion plane 22a opposite to recess plane 15a.

With this configuration, it is possible to secure the wall thickness of exterior member 10 between lead portion plane 22a and recess plane 15a. As a result, it is possible to inhibit occurrence of magnetic saturation in exterior member 10 between lead portion 22 and recess 15, and to inhibit decrease in the magnetic saturation current of inductor 100.

Moreover, each of lead portions 22 may have a thickness perpendicular to side surface 12a, and T/2≥dp may be satisfied, where T is a difference between thickness t1 of each of lead portions 22 and diameter di or thickness t2 of the wire of coil portion 21, and dp is a depth of each of recesses 15 that is recessed inward of side surface 12a.

With this configuration, it is possible to certainly inhibit that the wall thickness of exterior member 10 between lead portion 22 and recess 15 becomes thin. As a result, it is possible to inhibit occurrence of magnetic saturation in exterior member 10 between lead portion 22 and recess 15, and to inhibit decrease in the magnetic saturation current of inductor 100.

Moreover, each of lead portions 22 may have width w1 larger than diameter di or width w2 of the wire of coil portion 21.

With this configuration, for example, the sectional surface area of lead portion 22 can be increased compared to the case where width w1 has the same dimension as diameter di or width w2. As a result, DC resistance loss at lead portion 22 can be inhibited, and decrease in the inductance value of inductor 100 can be inhibited.

Moreover, an aspect ratio of a transverse cross section of the wire of coil portion 21 may be 1:1.

With this configuration, for example, the length of the magnetic path can be shortened compared with coil portion 21 whose wire has a board-shaped transverse cross section, and the magnetic efficiency can be improved.

The method for manufacturing the inductor according to the present embodiment is a method for manufacturing inductor 100 including (i) exterior member 10 including a magnetic material and having bottom surface 11 and side surface 12a connected to bottom surface 11 and (ii) electric conductive member 20 partially covered by exterior member 10. The method for manufacturing inductor 100 includes step S101 of forming the electric conductive member by pressing both ends of metal wire 120 using a press mold. The electric conductive member includes, on both sides sandwiching body 121 of metal wire 120, lead portion 22 and terminal electrode 23 each having a flat shape and being thinner than body 121. The method also includes step S103 of compression molding the magnetic material to cover body 121 and lead portions 22 and not to cover terminal electrodes 23 using a mold to form exterior member 10 and recesses 15 in side surface 12a of exterior member 10. Recesses 15 are connected to bottom surface 11. Lead portions 22 each are lead portion 22 and terminal electrodes 23 each are terminal electrode 23. The method also includes step S104 of bending each of terminal electrodes 23 from bottom surface 11 of exterior member 10 toward and along a corresponding one of recesses 15, and housing terminal electrode 23 in the corresponding one of recesses 15.

As described above, by making lead portion 22 thinner than body 121 of metal wire 120, inductor 100 can be manufactured without reducing the wall thickness of exterior member 10, which is outside the lead portion. As a result, it is possible to inhibit occurrence of magnetic saturation in exterior member 10, which is outside of lead portion 22, and to inhibit decrease in the magnetic saturation current of inductor 100. Moreover, expansion of the surface area for mounting inductor 100 can be inhibited by partially housing terminal electrode 23 in recess 15 in side surface 12a of exterior member 10. Furthermore, providing terminal electrodes 23 not only on bottom surface 11 but also in recesses 15 in side surface 12a makes it possible to form solder fillets, for example, when inductor 100 is mounted on a circuit board. With this, the connection strength of inductor 100 to the circuit board can be ensured.

Moreover, in step S103 of compression molding, the compression molding may be performed with lead portions 22 placed in the mold and a plane of each of lead portions 22 being in compression direction P1 of the compression molding. Lead portions 22 each have a flat shape.

With this, the magnetic material easily flows in along lead portion 22, and the density of exterior member 10 after compression molding can be increased. As a result, magnetic saturation is less likely to occur in exterior member 10, and decrease in the magnetic saturation current of inductor 100 can be inhibited.

Moreover, the method for manufacturing the inductor may further include, before step S103 of compression molding, step S102 of forming coil portion 21 by winding body 121 of metal wire 120 at least 0.5 turns and less than 1.0 turn. In step S103 of compression molding, the compression molding is performed with coil portion 21 placed in the mold and winding axis a1 of coil portion 21 being in compression direction P1 of the compression molding.

With this, the magnetic material easily goes also inside coil portion 21, and the density of exterior member 10 after compression molding can be increased. As a result, magnetic saturation is less likely to occur in exterior member 10, and decrease in the magnetic saturation current of inductor 100 can be inhibited.

### Other Embodiments, Etc.

Although the inductor, etc. according to the embodiment and so on of the present disclosure have been described above, the present disclosure is not limited to this embodiment.

For example, electric products or electric circuits including the aforementioned inductor are also included in the scope of the present disclosure. Examples of such electric products include a power supply apparatus including the inductor described above.

For example, in inductor 100 described above, the wall thickness of exterior member 10 between lead portion 22 and recess 15 may be thicker than the wall thickness of exterior member 10 between each straight part of coil portion 21 and side surface 12a. With this configuration, it is possible to inhibit occurrence of magnetic saturation in exterior member 10 between lead portion 22 and recess 15.

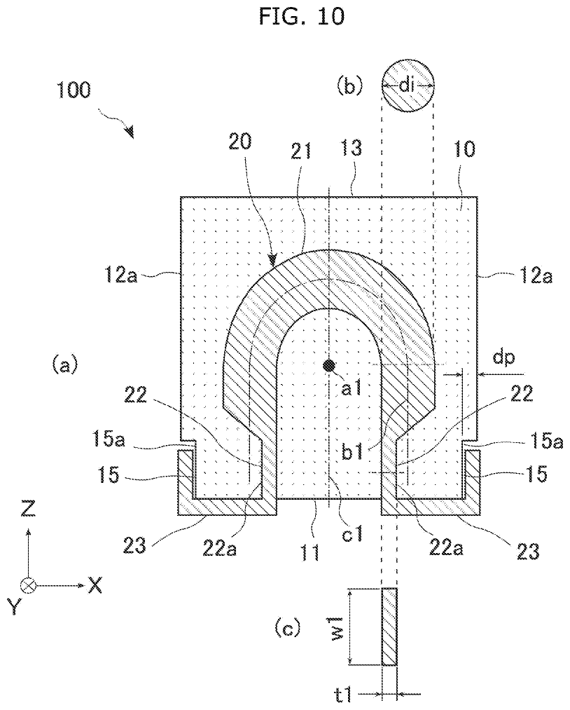

For example, an example in which flat portion 122 is formed along axis b1 of metal wire 120 has been described above, but the present disclosure is not limited to this example. Flat portion 122 may be formed at a position off axis b1 of metal wire 120. For example, by pressing metal wire 120 from the upper side with metal wire 120 placed on a base, flat portion 122 can be formed below axis b1. In other words, lead portion 22 does not necessarily have to be located along axis b1 of electric conductive member 20. Lead portion 22 may be located closer to the inner side, i.e., center line c1, of exterior member 10 than axis b1, as illustrated in FIG. 10. In this case, inductor 100 may be configured such that difference T between thickness t1 of lead portion 22 and diameter di of the wire of coil portion 21 is greater than or equal to depth dp of recess 15 (T≥dp).

Moreover, the present disclosure is not limited to the embodiment. Various modifications to the embodiment as well as embodiments resulting from arbitrary combinations of structural elements of different embodiments that may be conceived by those skilled in the art are intended to be included within the one or more aspects of the present disclosure as long as they do not depart from the essence of the present disclosure.

### INDUSTRIAL APPLICABILITY

The inductors according to the present disclosure are useful as inductors included in DC-DC converter devices.

1. An inductor comprising:
an exterior member including a magnetic material and having a bottom surface and a side surface connected to the bottom surface; and
an electric conductive member including a metallic material and partially covered by the exterior member, wherein
the electric conductive member includes (i) a coil portion covered by the exterior member, (ii) lead portions each connected to a corresponding one of both ends of the coil portion, extending toward the bottom surface, and covered by the exterior member, and (iii) terminal electrodes each connected to a corresponding one of the lead portions and exposed from the bottom surface of the exterior member,
the side surface of the exterior member includes recesses that are recessed inward of the exterior member from the side surface and connected to the bottom surface,
the terminal electrodes each extend along the bottom surface toward a corresponding one of the recesses, are bent from the bottom surface toward the corresponding one of the recesses, and housed in the corresponding one of the recesses,
at least a part of each of the lead portions is located opposite to the corresponding one of the recesses, and
each of the lead portions has a thickness smaller than a diameter or a thickness of a wire of the coil portion.

2. The inductor according to claim 1, wherein
each of the lead portions has a flat shape.

3. The inductor according to claim 1, wherein
each of the recesses includes a recess plane parallel to the side surface, and
each of the lead portions includes a lead portion plane opposite to the recess plane.

4. The inductor according to claim 1, wherein
each of the lead portions has a thickness perpendicular to the side surface, and
T/2≥dp is satisfied, where T is a difference between the thickness of each of the lead portions and the diameter or the thickness of the wire of the coil portion, and dp is a depth of each of the recesses that is recessed inward of the side surface.

5. The inductor according to claim 1, wherein
each of the lead portions has a width larger than the diameter or a width of the wire of the coil portion.

6. The inductor according to claim 1, wherein
an aspect ratio of a transverse cross section of the wire of the coil portion is 1:1.

7. A method for manufacturing an inductor including (i) an exterior member including a magnetic material and having a bottom surface and a side surface connected to the bottom surface and (ii) an electric conductive member partially covered by the exterior member, the method comprising:
forming the electric conductive member by pressing both ends of a metal wire using a press mold, the electric conductive member including, on both sides sandwiching a body of the metal wire, a lead portion and a terminal electrode each having a flat shape and being thinner than the body;
compression molding the magnetic material to cover the body and lead portions and not to cover terminal electrodes using a mold to form the exterior member and recesses in the side surface of the exterior member, the recesses being connected to the bottom surface, the lead portions each being the lead portion, the terminal electrodes each being the terminal electrode; and
bending each of the terminal electrodes from the bottom surface of the exterior member toward and along a corresponding one of the recesses, and housing the terminal electrode in the corresponding one of the recesses.

8. The method for manufacturing the inductor according to claim 7, wherein
in the compression molding, the compression molding is performed with the lead portions placed in the mold and a plane of each of the lead portions being in a compression direction of the compression molding, the lead portions each having a flat shape.

9. The method for manufacturing the inductor according to claim 7, further comprising:
before the compression molding, forming a coil portion by winding the body of the metal wire at least 0.5 turns and less than 1.0 turn, wherein
in the compression molding, the compression molding is performed with the coil portion placed in the mold and a winding axis of the coil portion being in a compression direction of the compression molding.
